(19) United States
(12) Patent Application Publication
(10) Pub. No.: US 2003/0006615 A1
(43) Pub. Date: Jan. 9, 2003

(54) Precisely controlled flying electric generators

(75) Inventors: Bryan William Roberts, Epang (AU); David Hammond Shepard, Coronado, CA (US)

Correspondence Address: SKY WINDPOWER CORPORATION, 4636 MISSION GORGE PLACE, SUITE #203, SAN DIEGO, CA, 92120, US

(73) Assignee: Sky WindPower Corporation, San Diego, CA

(21) Appl. No.: 10/064,806

(22) Filed: Aug. 19, 2002

(51) Int. Cl. F03D 9/00; H02P 9/04

(52) U.S. Cl. 290/55

(57) ABSTRACT

Tethered wind supported flying electric generators (FEGS) capable of deriving power from high altitude winds are held stable in precisely controlled positions in spite of wind fluctuations and temporary wind absence. FEGs are windmill-like rotorcraft, somewhat resembling helicopters, which are raised to a strong wind altitude using electric motors driving the rotors, each craft powered through tether(s) from a corresponding single point on the ground. Then the rotorcraft is tilted at an angle, the wind turns the rotors, and thus keeps the craft aloft and sends power back to the ground, now using the motors as generators. Precise craft geographic position, altitude and attitude are determined by various sensing means. Computer logic, provided with this information and wind and other weather data, command individual craft control functions and thus may also command arrays of these FEGs to maintain precise geographic and altitude locations or be grounded under tether winch control when necessary.

### BACKGROUND OF INVENTION

This invention relates to apparatus and methods for capturing the great energy obtainable from high altitude winds. More particularly, this invention relates to extracting power using apparatus held up, as are kites, by the wind itself and which incorporate wind-driven generators capable of transmitting power to the ground through tethers. In the prior art matters important to practical operation have not been addressed which are addressed herein.

Examples of methods in this field previously described include a paper entitled “Electricity Generation from Jet Stream Wind” by Fletcher and Roberts, appearing in the July-August 1979 issue of the Journal of Energy of the AIAA; a paper entitled “Tethered Gyroturbine Wind Energy System” by Noll and Ham delivered at the 2nd Wind Energy Innovation Systems Conference in Colorado Springs, Dec 3-5, 1980; U.S. Pat. Nos. 4,572,962 and 4,659,940 by Shepard; and numerous papers by the above Bryan W. Roberts. Roberts is the only one known to us who has actually flown an FEG in open air and generated power. Roberts and Shepard are responsible for the new invention covered below.

The above Paper by Noll and Ham is believed to constitute one of the first suggested uses of a tethered rotorcraft to capture and transmit high altitude wind energy to the ground, and this paper did contemplate use of a single tether. But it did not address certain aspects necessary for practical operation. As of this time, no apparatus capable of generating power from high altitude winds is known to be in operation. But, as above, Bryan Roberts, of the instant invention, did design and test a rotorcraft which generated power in 1986-87 in Australia flying sixty feet above a field, using tethers returned to separated points on the ground. This rotorcraft, at least in principle, could have been flown at much higher altitude.

It has long been known that there is enough energy contained in high altitude winds to supply all the world's energy needs many times over, but up until now no serious attempt has been made to use this source. In order to capture this energy economically and operate within guidelines practical in a civilized world, certain necessary aspects have not been addressed which are addressed in the present invention.

### SUMMARY OF INVENTION

In the current world a great deal of power is necessary to meet its needs, and wind driven generators, FEGs, tethered at high altitudes clearly can meet those needs. But they must be located in areas relatively remote from cities in order not to interfere with aircraft and meet other rules imposed by civil authorities, and operate safely and economically.

To fall within reasonable civil guidelines, except in really remote parts of the world, an array of FEGs must be confined to a reasonably small area on the ground and the airspace above it up to a defined altitude. Figures show that in most places in the United States a ten mile square area with airspace dedicated up to 29,000 feet, in some cases up to only 15,000 feet, should be able to accommodate an array of FEGs with a total output capacity in the thousands of megawatts. Or, in other words, power comparable to that of the hydroelectric output of the world's largest dams.

As is true of ground supported wind turbines, even at high altitude, wind is not always present, and it is sometimes necessary to ground FEGs for that reason and due to severe storms, etc. However, the persistence of winds at high altitudes makes the capacity factors for FEGs flying at high altitude very high, such as seventy to ninety percent, typically three times as high in the United States as found at ground based wind turbine sites. (Capacity Factor is the percent of rated capacity actually achieved. In the case of wind, the lack of wind persistence is the primary problem.) The result is that in combination with energy storage systems such as pumped water storage, the power derived using FEGs results in an efficient source of dependable power. This is an aspect important to electric utilities which cannot be achieved efficiently when the basic power source has a low capacity factor.

To accomplish the close spacing of FEGs necessary to produce power of substantial magnitude in a small area requires that each FEG fly with great stability at a precisely controlled altitude and geographic location relative to a ground reference frame. Furthermore, tethers to these closely spaced FEGs must not get tangled with each other.

This invention describes how individual rotorcraft may be held with great stability at high altitudes in precisely controlled locations individually and in arrays without interference with each other in spite of wind variations including gusts and short total absences using the above tethering principles. The necessary stability may be achieved using rotorcraft with varying numbers of power generating rotors, and methods for accomplishing this are described, as are varying means for assuring craft operation in the desired precisely controlled airspace locations.

### DETAILED DESCRIPTION

In embodiments of this invention described below, rotorcraft apparatus is held aloft with stability where using one, or a plurality, of revolving rotors are incorporated into a tethered platform that is entirely supported by the interaction of the said rotors with the wind. The platform is tethered with one, or a plurality of parallel tethers, which may incorporate electrical conductors for transmission of the electrical energy produced by the interaction of the rotors with the wind.

The rotors are mechanically connected through gears, or similar components, to one or more dynamos for the purpose of converting the mechanical energy developed by the rotor, or rotors, into electrical energy. Any dynamo may be used as a generator or a motor, and these may be AC or DC machines.

A single rotor platform is one comprised of one main and one dynamo in an airframe. A plurality of dynamos driven by the rotor may be used. To this airframe is also attached a generally smaller rotor, or similar thrust producing device, for the purpose of balancing or reacting the torque produced by the main rotor during the generation process. This torque reaction rotor is normally placed in a plane at right angles to that of the main rotor.

The platform is assembled with regard to the location of the center of gravity of the whole assembly. It is located close to and below the rotor's hub, or center of the main rotor. A single tethering cable, comprising a high tensile strength element, two or more conductors and suitable insulation material, is attached to the airframe in the general location of the center of gravity.

The platform carries suitable electronic apparatus to sense the orientation and position of the platform relative to a fixed frame of reference in space as hereinafter described. Platform pitch, roll and yaw angles relative to the fixed frame are thereby known.

The components for the single rotor arrangement in this invention include the following:

1. A single attachment point on the platform for the attachment of a single tether.

2. A swash plate, or similar mechanism, for tilting the rotor's thrust vector in the fore and aft direction.

3. A swash plate, or similar mechanism, for tilting the rotor's thrust vector in the lateral direction.

4. A mechanism for varying the collective pitch on the blades of the main rotor.

5. A mechanism for varying the thrust of the torque reaction rotor or similar device. Additionally a tail empennage may include, but not necessarily, the following:

6. A horizontal stabilizer with or without an elevator or similar device. Alternatively, the stabilizer may be all moving.

7. A vertical stabilizer with or without rudder.

Power extraction operations in wind are to be controlled by orientating the platform in pitch, roll and yaw by mixing the following bracketed items in any proportion, namely of (2.+6.), 3., (5.+7.) respectively, depending on the magnitude of the wind velocity.

The values of altitude and range are controlled by the mixing the (4.+2.+6.) functions in any proportion. The mixing proportion in all instances depends on the wind strength, which may vary from zero, during wind lulls, to significant values.

An alternative arrangement may be used using two tethers instead of one as described above. When using two tethers these are attached to the platform at points lateral to the main rotor. In this manner the lateral thrust tilting action on the main rotor (i.e. function 3 above) may be eliminated. By addition of one more extra tether (i.e. now making three in all) to an attachment point in the forward region of the platform then the fore and aft thrust-tilting function (i.e. function 2. above) may be deleted. In this latter case, the roll and/or pitch of the platform, relative to the fixed frame, may be controlled by lengthening or shortening one or more of the above mentioned three tethers. These tethers would be essentially parallel issuing from three winches normally located at a single point on the ground. By differential shortening or lengthening the tethers the craft can be controlled in pitch and/or roll. Height and/or range would be controlled by collectively shortening or lengthening all of the three tethers.

This differential shortening or lengthening procedure has been found to be effective for use with short tethers, namely when working with tethers operating at an altitude of say 500 to 1500ft. However, for longer tethers the tether-drape effect makes platform control imprecise and use of a single tether method for high altitudes is thus preferred.

A twin rotor configuration has been described on many occasions, particularly in a paper by Roberts entitled Flying Electric Generator to Harness Jetstream Energy delivered at the SPACE 2000 Conference of the American Society of Civil Engineers, pp1020-6, February-March 2000, Albuquerque, USA. This configuration used tethers from separated points on the ground.

A twin rotor platform is one comprising two preferably identical contra-rotating rotors with one or a plurality of dynamos. In this case no torque balancing methods are required. The rotors are mounted with their axes parallel and preferably disposed laterally relative to the prevailing wind vector. The rotor axes may be inclined at small angles of dihedral or anhedral to enhance the platform stability, if desired. In addition, the twin rotors can be mounted in an in-line configuration instead of being mounted laterally. While the in-line, or tandem, configuration is not preferred, it is workable.

In the presently described invention one tethering cable is preferred. It is attached to the platform near the central region, or near the center of gravity of the platform assembly. Alternatively, to reduce the bending moments in the platform's structure, and thereby reduce the platform's weight, one auxiliary tether may be attached adjacent to each rotor's thrust line while deleting the single attachment point mentioned above. These two auxiliary tethers then extend downwards to join at a confluence point located approximately one rotor's diameter below the platform. At the confluence point the two tethers merge into a single tether, which then extends from the confluence point to a single winch, or winch point, at ground level.

The following mechanical components are also included to achieve the necessary actions to control the platform in its location and orientation in a selected section of airspace:

1. A single attachment on the platform, or two auxiliary tethers joining at a single confluence point located below the platform.

2. A swash plate, or similar mechanism, for tilting each of the rotors” thrust vectors in the fore and aft direction.

3. A mechanism for varying the collective pitch on each rotor.

4. A horizontal stabilizer, either all-moving or with an elevator, to assist with the control, or to control, the craft's pitch attitude in wind.

5. A vertical stabilizer, with or without rudder, to assist with the control, or to control, the craft's yaw attitude into wind.

6. A wind sensor to ascertain the direction of the wind relative to the craft's reference axis.

During operations involving power extraction from the wind stream, the craft can be controlled in pitch, roll and yaw, relative to a fixed frame, by mixing the outputs, or actions, from the following mechanical items in any desired proportion:

Pitch controlled by collective action of item 2 above plus action of item 4.

Roll control by differential action on item 3.

Yaw control by differential action of item 2 plus action of item 5.

Total thrust control, and the ensuring power extraction level control, by collective action of item 3.

Mean height and range control of the platform as a whole by variation of the tether length, via the ground winch, inherent in item 1 plus action of the platform's pitch angle and by action of item 3, all as defined above.

In the event of the occurrence of no, or very light winds, the wind direction sensor signal is replaced by a ground orientated, directional signal, such as hereinafter described. The items 1 through 6 of this section of the current application are improvements to the systems proposed in prior publications.

A four rotor configuration and its control has been defined in a recent Australian Provisional Patent, PR8712, entitled Windmill Kite, lodged 7^{th} November 2001 in the name of Roberts. These rotors are arranged in a two by two square or rectangular configuration. The current patent application acknowledges this and particularly the fact that the above provisional application requires no fore and aft or lateral tilting of the thrust vector on any of its four rotors.

The invention described herein as applied to a four rotor configuration is directed towards a platform control strategy that ensures the correct orientation and location of the platform in any chosen portion of airspace using a single tether. This tether is attached to the platform at a single attachment point. In addition, the current invention embraces an optional improvement involving the use of four auxiliary tethers. These auxiliary tethers extend from four attachment points adjacent to the thrust lines of each of the four rotors. The four auxiliary tethers, or any other number of auxiliaries, extend downwards to a single confluence point located below the platform as described earlier. The object of the four short auxiliary tethers is to reduce the bending moments in the platform's airframe and thereby reduce the overall weight of that airframe.

In all the rotor configurations power is derived from the wind by tilting the rotorcraft at an angle which will permit the rotors driven by the wind to both support the rotorcraft and its tether(s) and transmitting the available remaining energy to the ground. The formula for what angle to assume at each different wind velocity and altitude is determined by differing characteristics of each rotorcraft configuration. The angle commanded, whether from on-board logic or ground computer, is based on stored formulae. Power is normally transmitted to the ground using high voltages, such as around fifteen kilovolts (15 kV) when operating at an altitude of 15,000 feet. This is to save conductor weight by using low currents. While tether strength and weights, including conductors and insulation, are critical design elements, newly available cord materials have extremely high strength to weight ratios, and the other needed elements are also commercially available to meet the needed tether requirements

Existing position of a rotorcraft relative to a ground frame of reference may be determined automatically by means such as radar, Global Positioning System (GPS), Carrier Phase Differential GPS (CDGPS) or inertial navigation technology. Historically, gyroscopic means have been used to keep track of current pitch, roll and yaw attitude information. However, if the positions at different locations on a rotorcraft are determined with sufficient precision, the attitude aspects of pitch, roll and yaw may also be determined by combining this positional information. For example, the pitch may be determined from the difference of altitude at extreme positions fore and aft on the rotorcraft.

Regardless of the technology used to determine rotorcraft position and attitude, error signals, that is, signals indicating direction and amount of a desired change, are used to control desired changes in attitude, rotor speed, and winch functions. In cases where error signals are transmitted from ground computers to the rotorcraft, radio communication is used transmitting digital codes. Conversely, information observed on the rotorcraft used by ground computers is also transmitted by radio using digital coding. The codes used are redundant to assure reliability. Alternatively, or redundantly, signals may be transmitted in either direction by superimposition on the electric power conductors of the tether.

The desired location of each rotorcraft is determined by ground based computers using both wind and weather data derived from external sources and wind speed and direction data measured on the rotorcraft themselves. In this determination the ground computers take into account geographic and altitude limits prescribed for the given high altitude wind power station and acceptable angle variations from the prevailing winds at which the rotorcraft may fly without interference with each other given the locations of the ground winching points and required separation distances.

For example, in a typical array layout, a line of winches perpendicular to the prevailing wind for that location may be established. Then substantial variation of the wind direction, such as forty five degrees in each direction, may be accommodated simply by close computer control of the FEG positions without moving the winches. Statistically, at most locations, this variation is sufficient to have negligible loss of energy due to unusual wind direction. In some locations, however, winches may be moved as conditions dictate.

The ground computers also supply desired artificial wind direction headings to the rotorcraft when needed when no reliable wind direction signal is available at the craft itself due to no or inadequate wind detected. If wind resumption is anticipated shortly, FEGs may be deliberately kept at altitude rather than grounding and raising again. (In this situation power will be supplied to the craft temporarily from the ground).

The ground computers, unless manually overridden, are also programmed to make the decisions on grounding craft because of insufficient wind or storms or possible lightning conditions, controlling such retrieval when necessary, and commanding provision of power to rotorcraft in ascent, or in order to temporarily maintain altitude in insufficient wind. It is to be understood that in the above use of the term ground computers this may mean a single computer, a network of computers or specially designed digital logic equipment.

As a matter of safety, it must be assumed that a tether may be severed or break in spite of design strength safety factors. This opens the possibility that the wind will carry an FEG beyond its prescribed operating limits. As the FEGs fly at considerable altitudes, sufficient potential energy due to this altitude will normally be available to permit an FEG to be guided back to its winching point in spite of the wind, although that is not described here. However, as an emergency measure, a well-known method may be used which utilizes two parachutes, not dissimilar, in principle, to the system used for the Solid Rocket Booster (SRB) recovery phase on the Space Shuttle. In this method, the first parachute is small, which makes the apparatus descend very rapidly until just above ground level, at which time the second much larger parachute opens to permit a soft landing. It is thus possible to ensure that the craft will not reach ground beyond its prescribed limits.

Although preferred embodiments of the invention have been disclosed herein in detail, it is to be understood that this is for the purpose of illustrating the invention, and should not be construed as necessarily limiting the scope of the invention since it is apparent that many changes can be made by those skilled in the art while still practicing the invention claimed herein.

1. For use in generating electrical energy from high altitude wind energy, apparatus comprising:
wind-driven electric generators;
a structure to hold said wind-driven generators
means to provide the lift necessary to hold said structure and generators at high altitude
a single tether comprising a high tensile strength light weight cord to hold said structure and said generators against the wind combined with insulated electrical conductors;
a winch at ground level for winding and unwinding the tether;
electrical equipment connected to the tether conductors at ground level to receive the energy transmitted therein and retransmit elsewhere or store said electrical energy and
means for positioning and maintaining said structure in a precisely defined location in a prescribed airspace despite the use of only a single tether.

2. Apparatus as claimed in claim 1 in which the means to provide the lift consists of rotors of the type used by helicopters and other rotorcraft which may be either powered by electric motors through a tether or turned by the wind itself when constrained by a tether.

3. Apparatus as claimed in claim 2 in which said rotorcraft are held in stable attitude by correcting deviations through altering rotor and airfoil functions using error signals provided to these controlling means indicative of determined attitude relative to desired attitude.

4. Arrays of apparatus as claimed in claim 1 controlled to operate and generate power in a relatively small prescribed airspace without interference between flying units of the arrays or their tethers.
